(19) United States
(12) Patent Application Publication
(10) Pub. No.: US 2007/0077963 A1
(43) Pub. Date: Apr. 5, 2007

(54) Network call director telephone

(76) Inventor: An-Min Hu, Fongyuan City (TW)

Correspondence Address: AN-MIH HU, P.O. Box 697, Fongyuan City, 420, TW

(21) Appl. No.: 11/214,832

(22) Filed: Aug. 31, 2005

(51) Int. Cl. H04B 1/38; H04M 1/00

(52) U.S. Cl. 455/557

(57) ABSTRACT

A network call director telephone includes a dome shaped housing inside which is an electronic circuit, an actuating switch and a microphone, outside which is an insertion groove, a plurality of air vents, a through hole for connecting external earphone or loud-speaker, a first cord connected a handset which has a microphone in upper portion and an acoustic receiver in the lower portion. The handset is able to anchor into the insertion groove with its tip lower end touching the actuating switch. A second cord respectively connects to a transmitter clip and an acoustic clip which are respectively inserting into their relevant sockets in a computer.

### BACKGROUND OF THE INVENTION

The present invention relates to computer network and more particularly to a network call director telephone which alters an earphone type into an ordinary telephone type in the network to coincide with the customary usage for the people.

As we know that the computer network becomes a necessities in modern society which is progressed from E-mail which transmits pure letter or image into nowaday's MSN which is capable of immediately transmitting information, sound and image that provides great convenience to the population. Usually, there must be an earphone or telephone to transmit the sound. Wherein the earphone has two clips, one of which connects to a microphone set of a computer and the other one connects to an earphone socket of the computer in order to receive the sound from other people. This type need no any driving program and/or extraordinary software. But a MSN system is necessary. It is very convenient. However, the earphone has a headband suspending from the top of the head in addition to a pair of housings on the ends that makes the user feeling uncomfortable. Further the headband always smashes the style of the hair so it is gradually disliked by the users.

Another type uses a telephone which has a USB plug inserted into a USB socket of the computer to coincide with is a software or a driving program enabling the telephone to be used in network communication. But it requires extraordinary software as well as the necessary orders so it cost more relative to an earphone.

### SUMMARY OF THE PRESENT INVENTION

The present invention has a main object to provide a network call director telephone which aims to provide a telephone type element instead the earphone but uses the clips of the earphone and microphone without utilizing the USB plug or extraordinary software and/or driving program and enables to use as a loud-speaker, especially having a shuttle like handset and a housing that is totally used as a telephone.

Accordingly, the network call director telephone of the present invention comprises generally a dome shaped housing in which is an electric circuit and a loud-speaker connected to a pair of cords extending to the outside, an insertion groove on a top for anchoring shuttle like handset which connects to one of the cords and has a microphone adjacent the top and an acoustic receiver above the lower end which is anchored into the insertion groove in which is an actuated switch touched by lower end-of the handset, the other cord respectively connects to a transmitter clip and a acoustic clip. When the handset leaves the actuating switch, it becomes an ordinary telephone handset above the housing.

The present invention will become more fully understood by reference to the following detailed description thereof when read in conjunction with the attached drawings.

### BRIEF DESCRIPTION OF THE DRAWINGS

FIG. 1 is a perspective view to show the preferred embodiment of the present invention while the handset is picked up from the housing,

FIG. 2 is a sectional view to show the details inside the housing,

FIG. 3 is a perspective view to show that the handset is released from the insertion groove,

FIG. 4 is a sectional view of FIG. 3, and

FIG. 5 is a diagram to show the electronic circuit inside the housing.

### DETAILED DESCRIPTION OF THE PREFERRED EMBODIMENT

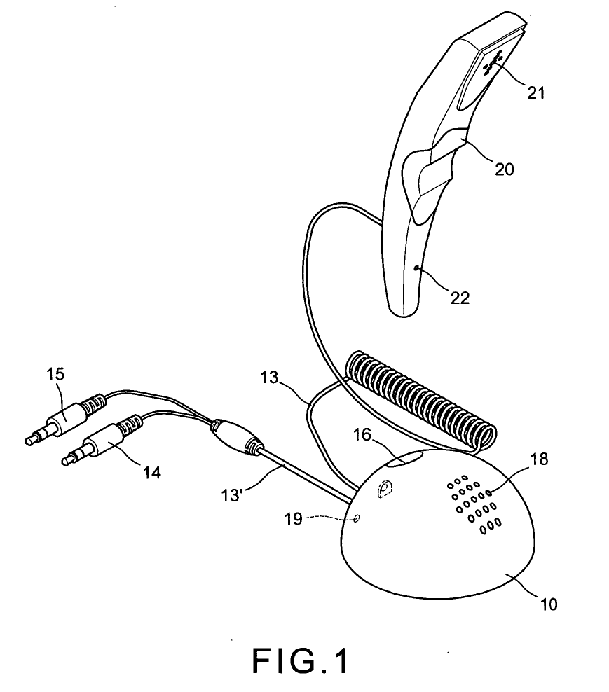

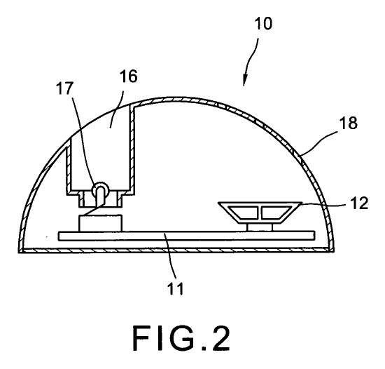

With reference to the drawings and initiated from FIGS. 1 and 2, the network call director telephone of the present invention comprises a dome shaped housing 10 which has an electronic circuit 11, a microphone 12 and the actuating switch 17 in inside the housing 10, a plurality of air vent 18 in front surface, a through hole 19 in a lateral side and an insertion groove 16 in a top for anchoring a shuttle like handset 20 which connected to inside of the housing by cord 13 and has microphone 21 adjacent the top and an acoustic receiver 22 above the sharp lower end which is capable anchored into the insertion groove and touched to the actuating switch 17 and another cord 13′ respectively connected with a transmitter clip 14 and an acoustic clip 15, wherein the through hole 19 is provide for receiving a plug of an earphone or a loud-speaker (not shown).

Upon the above described structure, in operation, inserting the transmitter clip 14 and the acoustic clip 15 into the relevant sockets in the computer. When uses the network linked immediate communication acoustic transmission which receives oval communication indicating signal, the microphone 12 inside the housing will emit the sound of bell ringing. Pick up the handset 20 that loud-speaker becomes silent, while the microphone 21 of the handset 20 transmits the sound from the opposing sides. Whereas the sound of the operator enable to transmit the voice to the opposing side through the acoustic receiver 22.

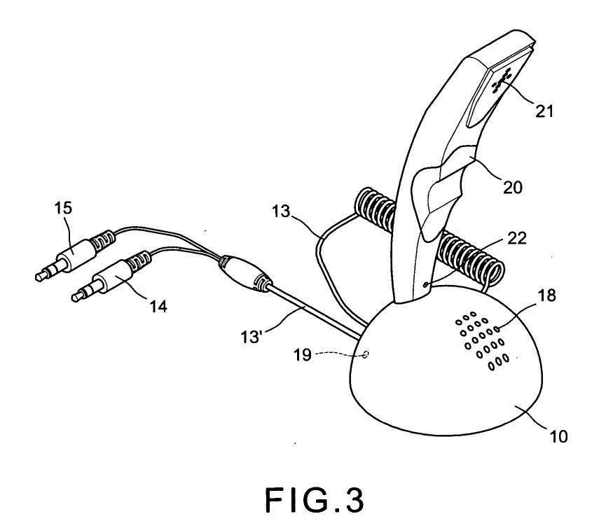

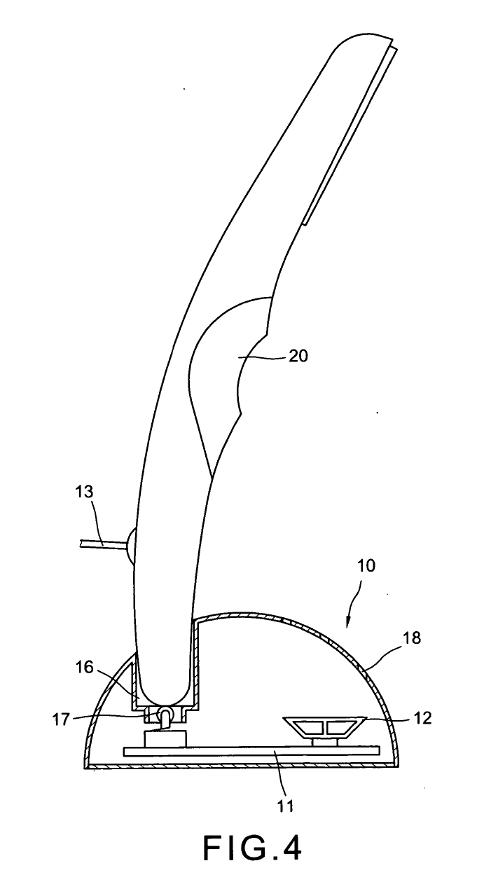

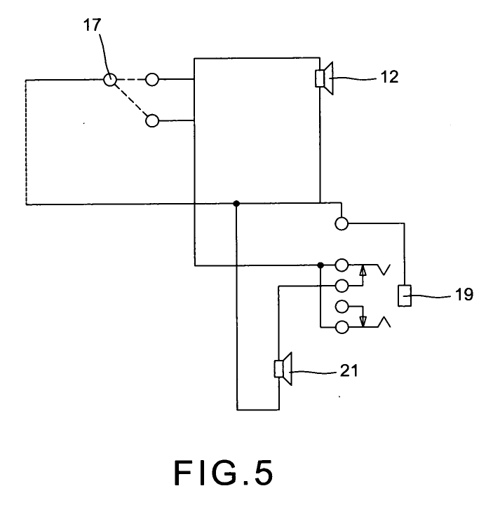

If discussion with the opposing side, don't have to put the handset 20 up (as shown in FIGS. 3, 4 and 5). Because the lower end of the handset 20 is touched to the switch 17, it enables the operator directly speaking to the housing 10, meanwhile the acoustic receiver 22 receives the sound of the operator and microphone transmits the sound the opposing side. This presents non-pick up the handset 20 state.

Conclusively the present invention is successfully use a housing 10 and a handset 20 instead of an earphone. The sound transmitting and receiving are intensified. Because of the through hole 19. Both an external earphone or loud-speaker can be connected. Due to the unusing of the USB socket, it requires no any extraordinary software or driving program. So it is easy to manufacture and capable of mass production in addition to its low malfunction it should be welcomed by the consumers.

Note that the specification relating to the above embodiment should be construed as an exemplary rather than as a limitative of the present invention, with many variations and modifications being readily attainable by a person of average skill in the art without departing from the spirit or scope thereof as defined by the appended claims and their legal equivalents.

I claim:

1. A network call director telephone comprising:
a dome shaped housing having an electronic circuit, an actuating switch and a microphone inside, an insertion groove in a top above the switch, a plurality of air vent in front side, a through hole in a lateral side, a first cord connected to a shuttle like handset which has a microphone adjacent top and an acoustic receiver above a sharp lower end which is capable of touching the actuating switch when the handset anchores into the insertion groove, and a second cord connects respectively with a transmitter clip and an acoustic clip which insert into relevant sockets in a computer.

2. The call director telephone as recited in claim 1, wherein said through hole is provided to connect an external earphone or a loud-speaker.
